(19) United States
(12) Patent Application Publication
(10) Pub. No.: US 2006/0042374 A1
(43) Pub. Date: Mar. 2, 2006

(54) External liquid level on shrink wrapped sleeve

(76) Inventor: Joseph M. Rait, Seattle, WA (US)

Correspondence Address: Howard M. Ellis;SIMPSON & SIMPSON, PLLC, 5555 Main St., Williamsville, NY, 14221, US

(21) Appl. No.: 10/924,605

(22) Filed: Aug. 24, 2004

(51) Int. Cl. G01F 23/00

(52) U.S. Cl. 73/290 R

(57) ABSTRACT

An external liquid level gauge determines the level of interface between a flowable material and the void volume above it within a container or storage tank. The flowable material has fluidic properties and a faster rate of heat transfer than the void volume. The liquid level gauge comprises at least one elongated strip of thermochromatic ink, typically a leucodye ink, that is affixed to one surface of a shrink wrap plastic material sleeve which is, in turn, shrunk onto the vertical periphery of the container and adhered in place by hoop stress established in the wrapper material. The wrapper may be heat or UV shrinkable, or it may be stretchable with an elastic memory.

### FIELD OF THE INVENTION

This invention relates to liquid level gauges, and particularly to liquid level gauges that are replaceable on containers and storage tanks for flowable materials having fluidic properties. Specifically, the present invention finds its greatest intended use on refillable tanks used for storage of liquefied gas such as propane, where use of the tanks is repeated a number of times by exchanging an essentially empty tank for one which is filled to its legal capacity at specially licensed propane filling and exchange sites. However, each time a tank is re-filled, it may have a new plastic outer wrapper placed over its periphery, and a new liquid level gauge which is associated with the new plastic wrapper.

### BACKGROUND OF THE INVENTION

Liquid level measuring devices have been known for many years. Their purpose is, of course, to measure the level of a liquid or other flowable material having fluidic properties within a container or storage tank therefor, where the container or storage tank is sealed and where there are no internal floats or sensors to determine the level of the liquid within the tank. Thus, in many instances it is not possible or practical to make a direct observation of the level of a fluidic flowable material, particularly in such containers as pressurized cylinders or other sealed containers, cryogenic flasks, opaque vessels, and the like. This is especially so when the fluidic flowable material within the container is corrosive or potentially toxic or flammable.

The use of propane is very popular particularly for providing fuel for outdoor barbecues. Such use is very common throughout North America, so much so that even during winter months in the northern states and in Canada, outdoor barbecues are still employed by persons wishing to have food prepared on such cooking devices. Of course, the use of barbecues is extremely widespread throughout the southern United States all during the year.

Moreover, the use of pressurized tanks containing liquefied propane is extremely widespread in the RV (recreational vehicle) industry. Typically, every RV is equipped with at least two propane tanks which must be periodically monitored so as to determine the amount of fuel contained therein, and the requirement to replace or refill such tanks.

However, the storage tanks in which liquefied propane is kept have a relatively small capacity, and periodically they need to be refilled or replaced. It used to be that an older tank could be taken to a refilling station, where the tank would be placed on a scale and liquefied propane would be transferred to the tank until such time as the overall weight of the tank and liquefied propane within it reached a predetermined amount. However, more and more, that practice is significantly changing for reasons of economy to some extent, but particularly also for reasons of safety. That is, in many jurisdictions refilling stations may not be permitted to fill an old tank; rather, the tank that the owner brings in is exchanged for another tank that has been prefilled to the permitted level. The old tank is then examined by qualified technicians who will determine if the tank may be permitted to be reused by another user for another barbecue or RV. If so, the tank may be purged of any remaining old gas, the valve may be replaced, an overfill valve may be installed, and the tank is put back in circulation for reuse. If not, the tank is scrapped.

From the point of view of the user of the tank, however, he or she must determine when the newly acquired tank will be exhausted of its propane charge and be required to be replaced by another tank. This typically requires, therefore, the use of some kind of liquid level gauge to determine at any time whether there is sufficient propane remaining in the tank to permit preparation from start to finish of the planned meal, or whether the tank must be replaced before food preparation begins. An RV owner may have other reasons as well to be concerned, such as providing heat for the interior living space of the vehicle, hot water heating, and so on. Thus, several external liquid level gauges of the sort described hereafter have been brought to the market and have entered the prior art.

From the point of view of the licensed operator of the refilling station, on the other hand, he or she wants to be in possession of a tank that is not rusted or otherwise is unattractive; and the operator also wants to be able to identify his or her station as the source of the product, as well as provide all the necessary warnings and precautions that may be required by labelling regulations in that specific jurisdiction. This has typically necessitated the repainting, if required, of a tank, and at least has required the cleaning and degreasing of the external surface of the tank, and the placement thereon of appropriate labels.

This does not, however, resolve the problem of placement of a liquid level gauge on the external periphery of the tank. The operator of the refilling and exchange station may elect to provide a prior art external liquid level gauge such as those that are magnetically adhered to the outside surface of the tank, or it may be left to the user of the tank to provide his or her own liquid level gauge.

Surprisingly, the present inventor has discovered that by providing a shrink wrap sleeve which may be shrunk around the periphery of a tank, and by placing a thermochromatic ink—which may be aqueous or non-aqueous—on the shrink wrap sleeve either before or after it is placed on the tank, then all of the labelling requirements that may be mandated in any particular jurisdiction can be met, and at the same time an accurate external liquid level gauge can be provided which permits the user of the tank to determine at any time the level of the liquid propane within the tank.

What is meant by referring to a shrink wrap sleeve is a pliable plastic sleeve which entirely encompasses a major portion of the periphery of a tank or container, and which is mechanically secured in place on the periphery of the tank as a consequence of hoop stress that is established in the pliable plastic sleeve when it is put into place. Typically, two kinds of such shrink wrap sleeve are used: the first is one which is made of a heat shrinkable material that is heat shrunk in place over the periphery of a tank. A variation of such a sleeve is one which may be UV shrinkable.

The other principal type of shrink wrap sleeve is one which is formed from a pliable plastic material having elastic memory. In that case, the material of the sleeve is stretched sufficiently to permit it to be placed over the periphery of a tank, and then the stretcher bars are removed permitting the elastic memory of the plastic material of the sleeve to shrink the sleeve into place and to be intimately secured to the periphery of the tank.

In all such instances, it will be understood that a hoop stress is established in the plastic material, and that hoop stress assures that the pliable plastic sleeve material is mechanically adhered to the periphery of the tank without the necessity for the use of an adhesive or other chemical substance.

Of course, the present invention will find use in many other circumstances and industries where a container or tank is replaced from time to time with another container or tank, and where it is necessary or desirable to determine in the meantime the level of a flowable material having fluidic properties that may be in the container or tank. Such uses may particularly be found in industries which supply beverages such as water, tea, juice, beer, or milk either for consumption or incorporation into other products, as well as for industries which supply such materials as alcohol, oil, other liquefied gases, corrosive liquids, and certain granular materials having fluidic properties and having a fast rate of heat transfer.

Thus, a solution is found that employs thermochromatic inks which may be either leucodye inks or cholosteric liquid crystal inks. The inventor herein has found particularly that leucodye inks, which may be aqueous or non-aqueous, are especially useful for the following reasons: It is well known that liquid crystal based thermochromatic inks have the advantage that they may be sensitive to very small changes in temperature; however, such inks are expensive and difficult to manufacture, and are difficult to handle. Leucodye inks, on the other hand, are relatively inexpensive and are relatively easy to handle. Moreover, leucodye inks are particularly useful in circumstances where an abrupt and profound change in temperature will occur, as is the case particularly when the level of propane in a tank is to be determined such as by pouring very hot water down the edge of the tank and observing the change of color in a preprinted strip of ink which functions as a liquid level gauge. Still further, leucodye inks may be formulated such that they will change from one color to another, rather than changing from a specific color to clear, when subjected to a temperature change of usually at least 3° C. or more. For example, a green ink may be formulated by adding a blue leucodye ink to a yellow ink so that when cool the printed ink layer appears to be green, but when warmed up it will revert to its yellow color as the leucodye ink becomes clear.

One further advantage of leucodye inks is that they may be formulated to change color at various temperature ranges, so that they may be employed in differing climactic conditions simply by printing more than one strip of ink on a shrink wrap sleeve for use as an external liquid level gauge; or by mixing several inks having different reaction temperatures at which a color change will occur for a specific one of the inks forming the mixture.

### DESCRIPTION OF THE PRIOR ART

A simple, economical external liquid level gauge which permits a direct reading of the level of a flowable material has been provided by the present inventor in U.S. Pat. No. 4,358,955 issued on Nov. 16, 1982. The liquid level measuring device taught therein employs one thermochromatic material which is coated onto a base layer. The base layer is magnetically mounted to the outside surface of the outside wall of the container, and thus the external liquid level gauge can be repeatedly removed and replaced or relocated when necessary.

The theory is that the rate of heat transfer is different between a mass of flowable material and the void volume above it such that for any container with a modest heat conducting capability, the container wall experiences a temperature gradient which is most pronounced at the interface of the contents with the void volume above the contents, and of course below that interface. That is to say, the rate of heat transfer through the wall of a container will be greater where there is a mass of flowable material located in the container than where there is a void volume above the flowable material. In other words, the rate of heat transfer through the container wall changes most abruptly at the level of the interface, and below. Thus, with the use of a thermochromatic material, a vivid colour change occurring at the interface, and below, will permit an observer to obtain a direct reading of the level of the flowable material within a container by discerning where the interface is located.

Several other prior art thermochromatic external liquid level gauges are now described. They include GILMOUR U.S. Pat. No. 3,696,675 issued Oct. 10, 1972 which teaches an external liquid level gauge adapted to be permanently affixed to the outside wall of a container for determining the liquid-gas interface within the container. The external liquid level gauge described therein consists of a uniform thermochromatic liquid crystalline material which coats the entire base layer of the gauge such that it is at right angles to the liquid-gas interface. The uniform thermochromatic material covers the entire temperature range to which the container is subjected within an overall range of −20° C. to 250° C. Depending upon the thermochromatic material selected, color changes over a gradient from violet to red can occur in a range as small as 2° C. to one as broad as 150° C. Since the temperature differential across the liquid-gas interface is generally small, on the order of less than 2° C., the change is color is slight across the interface. This is particularly the case when the container is placed outdoors and a large temperature range needs to be covered. As a result, it is difficult to visually locate the liquid-gas interface.

In U.S. Pat. No. 5,323,652 issued Jun. 28, 1994 to PARKER, the inventor teaches a thermochromic level indicator for determining the level of a material inside a container. The thermochromic level indicator includes at least two thermochromic materials of different opacities and transition temperature. Prior to the attachment of the thermochromic level indicator to the outside surface of the outside wall of the container, the thermochromic materials are applied to a transparent film by silk screening, other printing and coating methods, or methods which employ the use of microencapsulated thermochromic materials. The thermochromic level indicator may be permanently adhered to the container wall or it may be adhered to a magnetic strip which can be temporarily affixed to the container wall.

In another U.S. Pat. No. 5,707,590, issued Jan. 13, 1998, the inventor, THOMAS et al. has provided a detergent container with a thermochromatic level indicator. In one embodiment of the invention, the thermochromatic substance is added to the container's plastic material during the molding process. In another embodiment of the invention, the level indicator or strip comprises a base material, such as Mylar, which is coated or imbedded with a thermochromatic substance by such methods as painting, stripping, or screen printing.

In yet another U.S. Pat. No. 6,260,414 issued Jul. 17, 2001 to BROWN et al., the inventors teach a cholosteric liquid crystal fluid level indicator that determines the level of a cooled liquid, in particular beer, in a closed, opaque keg, and that indicates whether the beer in the keg is at its ideal temperature for consumption. Specifically, the cholosteric liquid crystal fluid level indicator as taught by BROWN et al. has a liquid crystal composition that produces a color change between a temperature range of 30° F. to 50° F. The inventors therein emphasize that this range is particularly crucial as it is consistent with the temperature of beer so that the level of beer may be readily determined by observing the color change of the cholosteric liquid crystal fluid level indicator. In addition, the cholosteric liquid crystal fluid level indicator produces a predetermined color when the beer is at its ideal temperature for consumption. The liquid crystal composition used in the cholosteric liquid crystal fluid level indicator taught by BROWN et al. is a cholosteric liquid crystal composition or cholosteric/chiral nematic liquid crystal mixture that exhibits at least one color, but preferably three, in a predetermined cooled temperature range. The cholosteric liquid crystal fluid level indicator operates such that when the close refrigerated environment experiences a slight and sudden change in temperature, such as when the refrigerator door is opened or the compressor turns off, then there will be a specific color display on the indicator from which an observer can determine whether or not the beer within the keg inside the refrigerator is at a suitable temperature for consumption.

It is important to note that the thermochromatic materials employed in the level gauges of all of the foregoing prior art are various forms of cholosteric liquid crystal compositions. As is known to those skilled in the art, cholosteric liquid crystal thermochromics are toxic and unfortunately very difficult to work with as they require highly specialized printing and handling techniques. Typically, silk-screen printing is required for the application of the cholosteric liquid crystal thermochromics onto a desired substrate. Due to the relatively small particle size of the cholosteric liquid crystal thermochromics, fine screen mesh, and thinner laydown are desirable. Such fine screen printing process is slow and tedious. Further, it increases the manufacturing costs of the level gauge, making it expensive and uneconomical to the consumers. Still further, the type of substrates on which the cholosteric liquid crystal thermochromics may be applied are limited. Moreover, typically any gauge which employs liquid crystal thermochromics must also employ an extra backing layer—usually black—on which the liquid crystal thermochromics are placed.

Two related United States Patent Application Publications, U.S. 2002/0157464 and U.S. 2003/0154784, each in the name of the present inventor, teach liquid level indicators which comprise a plurality of thermochromatic materials each of which responds chromatically within a different operating temperature range. The intent is to provide liquid level indicators which can function in a number of different climatic and/or temperature regimes, and which will provide an accurate indication of the liquid level of the mass of flowable material within the container. The external liquid level gauge is preferably intimately affixed to the outside surface of the outside wall of a container, such as by being printed or otherwise transferred directly thereto.

### SUMMARY OF THE INVENTION

In accordance with one aspect of the present invention, there is provided an external liquid level gauge for determining the level of the interface between a mass of flowable material and the void volume thereabove within a container or storage tank therefor. The gauge is adapted to extend vertically along substantially the entire height of the container.

The flowable material has fluidic properties, and has a faster rate of heat transfer than the void volume above it within the container.

The gauge comprises at least one elongated strip which is affixed to one surface of a shrink wrap plastic material sleeve. The sleeve is adapted to be adhered onto the vertical periphery of the container to which it is to be affixed by hoop stress which is established in the sleeve when it is put into place over the periphery of the container.

The elongated strip is a thermochromatic ink.

Typically, the thermochromatic ink is a leucodye ink.

However, the thermochromatic ink may also be a cholosteric liquid crystal ink.

Typically, the elongated strip of thermochromatic ink is affixed to the outer surface of the shrink wrap plastic material sleeve.

However, the elongated strip of thermochromatic ink may be affixed to the inner surface of the shrink wrap plastic material sleeve.

The at least one elongated strip of thermochromatic ink may be affixed to the one surface of the shrink wrap plastic material sleeve by different processes, including printing, silk screening, offset lithography, flexography, gravure, stencilling, spraying, crayon transfer, affixing a previously prepared panel already having at least one strip of thermochromatic ink adhered thereto, or combinations thereof.

Typically, the flowable material is chosen from the group consisting of water, alcohol, oil, coffee, tea, juice, beer, milk, liquefied gas, corrosive liquid, and granular material.

The material of the shrink wrap plastic sleeve may be heat shrinkable, UV shrinkable, or stretchable having an elastic memory.

For example, the shrink wrap plastic material sleeve may be made from a material which is shrink wrap by the application of ultraviolet light.

In that case, the at least one elongated strip of thermochromatic ink may be a non-aqueous leucodye ink which is applied from a non-aqueous slurry thereof and which is settable when exposed to ultraviolet light after it has been affixed to the one surface of the shrink wrap plastic material sleeve.

Alternatively, a non-aqueous ink may be employed that is settable by other means, including exposure to heat, lapse of time, etc.

In general, the container may be chosen from a group of containers which consists of pressurized cylinders, open containers, sealed containers, cryogenic flasks, opaque vessels, and beer casks.

The leucodye ink may be a mixture of leucodye inks, each having different reaction temperatures. Thus, at different temperatures, one or another of the leucodye inks which make up the mixture will change color.

Also, it is typical that when leucodye inks are employed, after they have been put in place they will be coated with a coating which contains UV inhibitors.

If so, typically that coating is a lacquer, but other coatings having UV inhibitors may be used as well.

Moreover, it should be noted that the leucodye ink may be chosen from the group consisting of aqueous leucodye inks and non-aqueous leucodye inks.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a generalized view showing the application of a shrink wrap sleeve to a gas storage tank, and showing in dotted line the placement of the shrink wrap sleeve and a printed liquid level gauge thereon; and

FIG. 2 is a rendering of a typical instruction panel which is printed on a shrink wrap sleeve to be placed over the outer periphery of a propane tank.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

It has been noted above that a particular need arises in the market for the supply of liquid level indicators and gauges, particularly for use in that segment of the market which provides refilled propane gas containers to users thereof. The refilled containers, however, must have passed a rigorous inspection, and may also have been repainted as well as having been cleaned and degreased.

Moreover, it has been noted that the use of a shrink wrap plastic material sleeve, as described above, and placed over the outer periphery of a propane container serves a number of purposes. Included among them are the provision of a liquid level gauge to the user of the propane container, identifying the supplier if required or as may be mandated, providing instructions as to the use of the liquid level gauge, and providing such other required or mandated warnings and the like that are typical for containers of liquefied flammable gases.

The use of a shrink wrap plastic material sleeve is particularly advantageous, because such a sleeve is generally rugged enough to withstand the handling of the propane container by the user thereof, and at the refilling and exchange station; and yet, the shrink wrap plastic material sleeve is such that it may be removed from the periphery of the propane container by skilled technicians at the refilling and exchange station, such as by the use of specialized knives. Thus, the returned container may easily be inspected and cleaned, with a major portion of the outer periphery of the container being relatively clean and free of grease due to the prior presence of a shrink wrap sleeve during previous use of the container.

By being secured in place as a consequence of the hop stress developed in the shrink wrap sleeve when it was first put into place, the use of adhesives is obviated.

It should also be noted that sometimes it may be advantageous for a liquid level gauge in keeping with the present invention to comprise more than one elongated strip of thermochromatic ink affixed to the surface of a shrink wrap plastic material sleeve, so as to find utility in a variety of climactic conditions. However, the principal remains the same; and that is that the thermochromatic ink will change color when subjected to a temperature difference. Moreover, a plurality of different inks, each having a different reaction temperature, may be employed in a single strip.

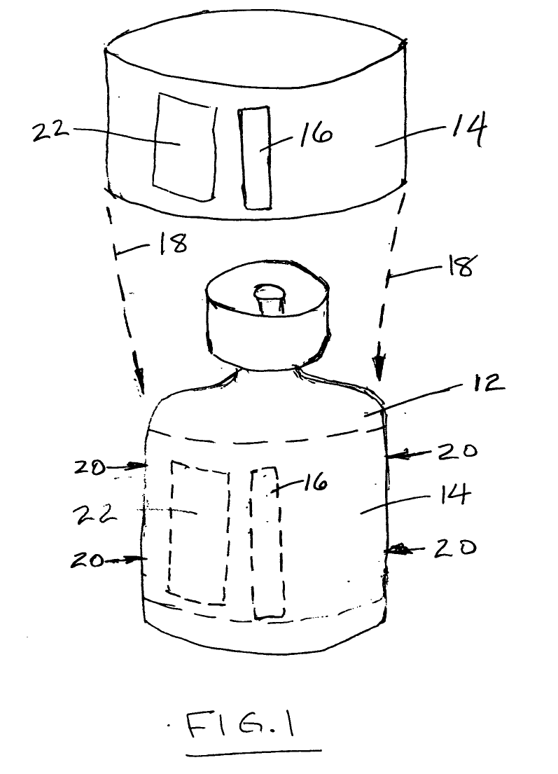

Turning to FIG. 1, a container or tank 12 is shown together with a shrink wrap sleeve 14 having at least one elongated strip of thermochromatic ink 16 printed or otherwise affixed to one surface of the shrink wrap plastic material sleeve. The precise material of the plastic material sleeve 14 is beyond the scope of the present invention, but is well known to those skilled in the art. Several typical examples have been noted above.

However, it is important to note that when the shrink wrap plastic material sleeve 14 is in place over the periphery of the container or tank 12, it is adhered thereto as a consequence of the hoop stress which is established in the shrink wrap sleeve as a consequence of the manner in which it has been put into place.

As an example, the shrink wrap the shrink wrap plastic material sleeve may be one which is shrinkable when exposed to ultraviolet light. Alternatively, as noted, it may be heat shrinkable, or it may be a material having an elastic memory that has been stretched and permitted to recover as a consequence of its elastic memory.

Typically, the shrink wrap plastic material sleeve 14 is placed over the outer periphery 20 of the tank 12 as indicated by arrows 18, and is then shrunk in place, as discussed above.

The flowable material which is within the container or tank 12 is a material that has a faster rate of heat transfer then the void volume above it within the container. Thus, when the external liquid level gauge elongated strip or strips 16 is exposed to a temperature change, as will be described immediately below, then the rate of heat transfer between the mass of flowable material within the tank through the tank or container wall will be different than the rate of the transfer between the void volume above the mass of flowable material through the tank or container wall, for any container having a modest heat conducting capability. Accordingly, if very hot water is poured or trickled down the outer periphery of the storage tank 12, then the wall of the storage tank 12 will experience a temperature gradient which is most pronounced at and below the interface between the mass of flowable material within the tank and the void volume above it. In other words, the temperature of the container wall of the tank 12 will change most abruptly at and below the interface.

Since the shrink wrap plastic material sleeve 14 is in intimate heat transfer relationship with the outer periphery of the wall of the container 12, then the introduction of a heat transfer-inducing agent, particularly such as hot water as will be described hereafter, will cause the thermochromatic ink to undergo a color change provided that it has an operating temperature range which encompasses the temperature of the heat transfer-inducing agent, and will thus exhibit a profound color change responsive to transfer between the heat transfer-inducing agent and the mass of flowable material which has a faster heat transfer rate than the void volume above it. Thus, the interface will be easily detected.

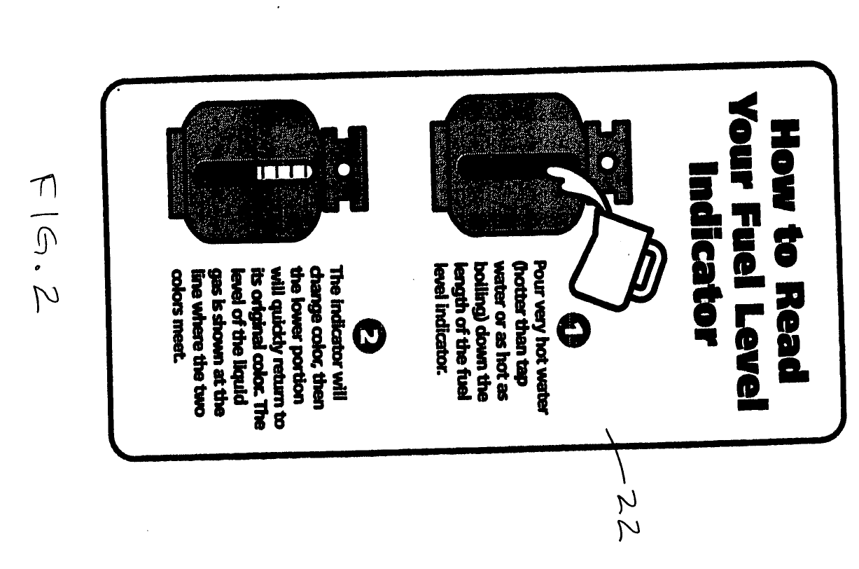

Turning to FIG. 2, a typical instruction panel which may be printed beside the at least one elongated strip of thermochromatic ink 16, is shown. The text which is contained within the instruction panel 22, and the sketches of a typical propane tank having at least one elongated strip of thermochromatic ink printed on the shrink wrap plastic material sleeve, provide a concise summary of a typical operation of the present invention. Thus, it is noted that the instructions require the user to pour very hot water down the length of the at least one elongated strip of thermochromatic ink; and that the strip of thermochromatic ink will change color. However, it is noted that the lower portion of the at least one elongated strip of thermochromatic ink will quickly return to its original color—due, of course, to the faster rate of heat transfer of the material within the tank than the rate of heat transfer of the void space above it. Accordingly, the level of the liquid gas, in this case, can easily be determined to be at the location where the two colors meet.

Of course, it will be understood that over a period of time—typically less than one hour—the at least one elongated strip of thermochromatic ink will revert to its original color as the heat caused by the presence of the very hot water is dissipated and the entire container 12 reacquires a temperature in keeping with the ambient.

If the shrink wrap plastic material sleeve 14 is heat shrinkable, it may be heat shrunk to the outer periphery of the container 12 by the application of heat such as a warm air stream or bath. On the other hand, the present invention also provides for the use of a shrink wrap plastic material sleeve which is shrinkable by the application of ultraviolet light. This feature, when coupled particularly with the use of a thermochromatic leucodye ink which is applied from a non-aqueous slurry so as also to be settable when exposed to ultraviolet light, permits an easy and easily controllable process for applying a shrink wrap plastic material sleeve to a container at an appropriate time prior to its reuse.

It will be understood that the at least one elongated strip of thermochromatic ink, particularly when it is a leucodye ink carried in a non-aqueous slurry, might in some circumstances be applied to the outer surface of the featuring about plastic material sleeve after it has been applied to the container. If so, then it is possible that the material of the shrink wrap plastic material sleeve may be such that it is shrinkable by being exposed to warm air, for example; and that the elongated strip of leucodye thermochromatic ink will be settable when exposed to ultraviolet light without affecting the already heat shrunk sleeve.

Of course, it will be understood that in any event the precise method that is employed to affix the at least one elongated strip of thermochromatic ink to one surface of the heat shrunk about plastic material sleeve, while it might usually be chosen from such processes as printing, silk screening, offset lithography, flexography, gravure, stencilling, spraying, crayon transfer, or combinations thereof, can indeed be printed by any appropriate method known to those skilled in the art. Moreover, it will be evident that the at least one elongated strip of thermochromatic ink may be affixed to either the inside surface or the outside surface of the shrink wrap plastic material sleeve, although typically it is the outside surface of the sleeve where the thermochromatic ink and other printed material such as the instruction panel 22 will be found. It is also evident that in some circumstances the elongated strip of thermoplastic ink may be applied to the outside surface of the shrink wrap plastic material sleeve after it has been applied to the outer periphery of the container, especially in circumstances where the thermochromatic ink is a leucodye ink that is carried in an ultraviolet settable, non-aqueous slurry.

Moreover, it will be understood that the at least one elongated strip of thermochromatic ink 16 may, indeed, be printed on a separate panel which, itself, may then be affixed to a separate panel which, itself, may then be affixed to the shrink wrap plastic sleeve material before or after it has been shrunk onto a tank. This permits the use of slower setting or drying leucodye inks, in particular, including non-aqueous ink formulations.

It should also be noted that the elongated strip of the thermochromatic ink 16 may, when it is comprised of leucodye inks, include more than one leucodye ink which have different reaction temperatures. Thus, several inks may be combined which will typically become clear at a specific reaction temperature, leaving another ink to reveal a different color as a result of the mixture of the color of the remaining inks. Accordingly, the level of the interface between the flowable mass and the void volume above it may be easily determined in different ambient temperature conditions.

Also, it is common as is known to those skilled in the leucodye ink art, to coat the leucodye ink or inks after they have been cured with a lacquer coating which contains UV inhibitors. This precludes deterioration of the inks when exposed to sunlight. Typically, such coating is a lacquer coating.

Moreover, as noted, the leucodye inks which are employed may be aqueous or non-aqueous, depending on the circumstances surrounding the manner of printing or applying the ink, and the nature of the shrinkable wrap material on which it is applied, as will be known to those skilled in the leucodye printing arts.

It will also be understood that various containers other than propane tanks will find themselves equally adaptable to the present invention, including varieties of pressurized cylinders, some open containers as well as sealed containers, cryogenic flasks, opaque vessels, and beer casks.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, use of the terms “he”, “him”, or “his”, is not intended to be specifically directed to persons of the masculine gender, and could easily be read as “she”, “her”, or “hers”, respectively.

1. A labeling sleeve suitable for mounting to the periphery of a storage container or tank, which comprises at least one elongated liquid level gauge in the form of a strip adapted to extend vertically along the height of said storage container or tank, and a sleeve for holding said liquid level gauge, said gauge comprising at least one thermochromatic ink and means for protecting said thermochromatic ink from deterioration applied thereto when exposed to UV light, said gauge being suitable for determining the level of the interface between a mass of flowable material and the void volume thereabove within said storage container or tank, said sleeve comprising a plastic shrinkable or stretchable wrap having an inner surface for engaging with said storage container or tank and an outer surface opposite said inner surface, said outer surface comprising printed instructional indicia and said liquid level gauge, allowing setting of said thermochromatic ink when said ink is UV settable without affecting an already heat shrunk sleeve, and also permitting application of said means for protecting said thermochromatic ink from UV light after said sleeve is applied to said storage container or tank.

2. The labeling sleeve according to claim 1, wherein said thermochromatic ink is a leucodye ink.

3. The labeling sleeve according to external liquid level gauge of claim 1, wherein said thermochromatic ink is a cholosteric liquid crystal ink.

4. (canceled)

5. (canceled)

6. The labeling sleeve according to claim 1, wherein said at least one elongated liquid level gauge comprising said thermochromatic ink is affixed to said sleeve by a process selected from the group consisting of printing, silk screening, offset lithography, flexography, gravure, stenciling, spraying, crayon transfer, affixing a previously prepared panel already having an at least one strip of thermochromatic ink adhered thereto, and combinations thereof.

7. The labeling sleeve according to claim 1, wherein said flowable material is a member selected from the group consisting of water, alcohol, oil, coffee, tea, juice, beer, milk, liquefied gas, corrosive liquid, and granular material.

8. The labeling sleeve according to claim 1, wherein said sleeve is formed from a pliable plastic material having a shrinkable characteristic selected from the group consisting of heat shrinkable and a stretchable material with elastic memory.

9. The labeling sleeve according to claim 8, wherein said sleeve is shrinkable by the application of ultraviolet light; and wherein said at least one elongated strip of thermochromatic ink is a non-aqueous leucodye ink which is applied from a non-aqueous slurry which is settable when exposed to ultraviolet light after it has been affixed to said outer surface of said shrink wrap plastic material sleeve.

10. (canceled)

11. The labeling sleeve according to claim 9, wherein said non-aqueous leucodye ink is settable by exposure to heat or by lapse of time.

12. The labeling sleeve according to claim 1, wherein said container is a member selected from the group consisting of pressurized cylinders, open containers, sealed containers, cryogenic flasks, opaque vessels and beer casks.

13. The labeling sleeve according to claim 2, wherein said leucodye ink is a mixture of leucodye inks having different reaction temperatures at which color change will occur for any one specific leucodye ink of said mixture.

14. The labeling sleeve according to claim 2, wherein said leucodye ink is covered with a lacquer coating comprising a UV inhibitor for protecting said ink from deterioration.

15. (canceled)

16. The labeling sleeve according to claim 2, wherein said leucodye ink is a member selected from the group consisting of aqueous leucodye inks and non-aqueous leucodye inks.

17. A propane tank comprising the labeling sleeve according to claim 1.

18. A propane tank comprising the labeling sleeve according to claim 2.

19. A propane tank comprising the labeling sleeve according to claim 3.

20. A propane tank comprising the labeling sleeve according to claim 6.

21. A propane tank comprising the labeling sleeve according to claim 8.

22. A labeling system suitable for mounting to the periphery of a storage container or tank, which comprises:
(i) a plastic, heat shrinkable or stretchable wrap sleeve having an inner surface and an outer surface opposite said inner surface, wherein said inner surface engages with said storage container or tank, and
(ii) at least one elongated liquid level gauge strip for determining the level of the interface between a mass of flowable material and the void volume thereabove within said storage container or tank, said liquid level gauge strip comprising
(a) at least one thermochromatic ink applied to a substrate separate from said wrap sleeve and
(b) means for protecting said thermochromatic ink from deterioration when exposed to UV light, said liquid level gauge strip being suitable for affixing to either said inner surface or said outer surface of said wrap sleeve.

23. The labeling system of claim 22, wherein said thermochromatic ink is a member selected from the group consisting of a leucodye ink and a cholosteric liquid crystal ink.

24. The labeling system of claim 22, wherein said at least one elongated strip of thermochromatic ink is a non-aqueous leucodye ink applied to said separate substrate from a non-aqueous slurry which is settable when exposed to ultraviolet light.

25. The labeling system of claim 22, wherein at least one of said inner and outer surfaces of said plastic, heat shrinkable or stretchable wrap sleeve comprises printed instructional indicia for the user.

26. A propane tank comprising the labeling system according to claim 22.
